(19) United States
(12) Patent Application Publication
(10) Pub. No.: US 2002/0129119 A1
(43) Pub. Date: Sep. 12, 2002

(54) Information distribution device and information distribution method

(76) Inventors: Hideyuki Aoki, Kawasaki (JP); Norio Murakami, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/919,204

(22) Filed: Jul. 31, 2001

(30) Foreign Application Priority Data
Mar. 12, 2001 (JP) 2001-067984

(51) Int. Cl. G06F 15/16; G06F 15/173

(52) U.S. Cl. 709/217; 709/225

(57) ABSTRACT

A server stores terminal information including an address of each terminal device belonging to a group constituted by a plurality of terminal devices. The server receives, from a terminal device belonging to the group, a distribution request including access information and distribution destination information. The server accesses the distribution information based on the access information, and receives the distribution information. The server specifies an address of a distribution destination terminal device based on the distribution destination information, and distributes the received distribution information to the destination terminal device.

### BACKGROUND OF THE INVENTION

1. Field of the Invention

The present invention relates to an information distribution device, information distribution system, information distribution method and information distribution program product, and more particularly to an information distribution device, information distribution system, information distribution method and information distribution program product for distributing information to a plurality of terminal devices.

Further, the present invention relates to a terminal device for sharing information.

2. Description of the Related Art

Through the widespread use of the Internet and personal computer-based communications, it has become possible to easily retrieve and reference a variety of information (contents) via telecommunications networks.

In this context, there are cases, in a company, in which, either a certain employee is required to send information received via a telecommunications network to other employees, or there is a desire to send same. Further, in a private group also, there are cases in which, either it is necessary for a certain member of the group to send information received via a telecommunications network to other members, or there is a desire to send same. That is, there are cases in which, either there is a need to share information among a plurality of employees or members of a group, or there is a desire to share same.

To date, such information sharing has been carried out by a person, who has initially received information, sending a URL (Uniform Resource Locator), for a Web site, which represents the storage location of this information, to a sharing partner. A sharing partner then uses his own terminal to specify the sent URL, access the Web site and acquire (reference) the information. Thus, information is shared between a person, who initially received the information, and a sharing partner.

However, with such conventional information referencing, a sharing partner must perform a series of operations, such as specifying a URL, by using his own terminal. Consequently, when the operation is troublesome, a sharing partner is made to perform a troublesome operation. Further, when there is a plurality of procedures for reaching an information storage location, for example, in a case in which a plurality of options are selected, there is also the danger that the final storage location cannot be reached.

Furthermore, there are also cases in which information cannot be sent as-is due to differences in the terminals being used. For example, there are cases in which the format of a display portion will differ according to the terminal, making it impossible to display information on a display portion without further processing.

Furthermore, in a conventional information sharing method, when there is a charge for information, a sharing partner is made to bear the costs of referencing information. Thus, there are cases in which a sharing partner will hesitate to access information that needs to be shared, and there are also cases in which information sharing is not performed smoothly.

### SUMMARY OF THE INVENTION

With the foregoing in view, it is an object of the present invention to enable the sharing of information without an information-sharing partner being burdened by either troublesome or complicated procedures.

Further, another object of the present invention is that an information sharing partner not be made to bear the expense for receiving information.

To achieve the above-mentioned objects, an information-sharing device according to a first aspect of the present invention comprises a first storage portion for storing terminal information including an address of each terminal device belonging to a group constituted by a plurality of terminal devices; a first receiving portion for receiving, from a terminal device belonging to the above-mentioned group, a distribution request including access information, which is necessary for accessing distribution information, which is distributed to all, some or one of the terminal devices belonging to the above-mentioned group, and distribution destination information which specifies a distribution destination terminal device belonging to the above-mentioned group; a second receiving portion for accessing the above-mentioned distribution information based on the above-mentioned access information included in the distribution request received by the above-mentioned first receiving portion, and for receiving this distribution information; a second storage portion for storing the above-mentioned distribution information received by the above-mentioned second receiving portion; and a first transmitting portion for specifying an address of a distribution destination terminal device based on the above-mentioned distribution destination information included in the distribution request received by the above-mentioned first receiving portion, and the terminal information stored in the above-mentioned first storage portion, and for distributing the above-mentioned distribution information stored in the above-mentioned second storage portion to the above-mentioned specified destination terminal device.

Further, an information-sharing method according to a first aspect of the present invention is an information distribution method performed by a server device, in which terminal information is stored including an address of each terminal device belonging to a group constituted by a plurality of terminal devices and involves receiving, from a terminal device belonging to the above-mentioned group, a distribution request including access information, which is required for accessing distribution information, which is distributed to all, some or one of the terminal devices belonging to the above-mentioned group, and distribution destination information which specifies a distribution destination terminal device belonging to the above-mentioned group, accessing the above-mentioned distribution information based on the above-mentioned access information included in the above-mentioned received distribution request to receive this distribution information, specifying an address of a distribution destination terminal device based on the above-mentioned distribution destination information included in the above-mentioned received distribution request, and the above-mentioned stored terminal information, and distributing the above-mentioned received distribution information to the above-mentioned destination terminal device.

According to the first aspect of the present invention, distribution information is transmitted to all, some or one of the terminal devices belonging to a group in accordance with a distribution request from a certain terminal device belonging to the same group. Distributed information is thus shared among terminal devices belonging to the group. Further, the sharing of information is performed without placing the burden of procedures for referencing (acquiring) information on a terminal device (on the user thereof) other than the terminal device which transmitted the distribution request.

Further, since the (user of the) terminal device, which submitted the distribution request, bears the costs of referencing (acquiring) information for which there is a charge, information is shared without other terminal devices (the users thereof) being made to bear the costs of referencing (acquiring) information Further, a terminal device according to a second aspect of the present invention comprises a registration portion for registering terminal information, including the address of each terminal device belonging to a group constituted by a plurality of terminal devices, via a telecommunications network in an information distribution device connected to this telecommunications network; and a transmitting portion for transmitting, to the above-mentioned information distribution device, a distribution request including access information required for accessing distribution information, which is distributed either to all, some or one of the terminal devices belonging to the above-mentioned group, and distribution destination information which specifies a distribution destination terminal device belonging to the above-mentioned group.

An information distribution method according to the second aspect of the present invention is performed by a terminal device connected to a telecommunications network, and involves registering terminal information, including the address of each terminal device belonging to a group constituted by a plurality of terminal devices, via the above-mentioned telecommunications network in an information distribution device connected to this telecommunications network, and transmitting a distribution request including access information which is required for accessing distribution information, which is distributed to all, some or one of the terminal devices belonging to the above-mentioned group, and distribution destination information, which specifies a distribution destination terminal device belonging to the above-mentioned group, to the above-mentioned information distribution device.

According to the second aspect of the present invention, information is distributed by a certain terminal device, which belongs to a group registered in an information distribution device, transmitting an information distribution request to a terminal device of the same group. Distributed information is thus shared among terminal devices belonging to the group. Further, information-sharing is performed without placing the burden of procedures for referencing (acquiring) information on a terminal device (on the user thereof) other than the terminal device which transmitted the distribution request.

Furthermore, in an information distribution system according to a third aspect of the present invention, a plurality of terminal devices and an information distribution device are connected to a telecommunications network, and the above-mentioned terminal devices comprise a registration portion for registering terminal information, in the above-mentioned information distribution device, via a telecommunications network, which information includes an address of each terminal device belonging to a group constituted by a plurality of terminal devices, and a transmitting portion for transmitting to the above-mentioned information distribution device, a distribution request including access information, which is required for accessing distribution information, which is distributed to all, some, or one of the terminal devices belonging to the above-mentioned group; and distribution destination information, which specifies a distribution destination terminal device belonging to the above-mentioned group, and the above-mentioned information distribution device comprises a first storage portion for storing terminal information registered by the above-mentioned registration portion of the above-mentioned terminal device, a first receiving portion for receiving the above-mentioned distribution request transmitted by the above-mentioned transmitting portion, a second receiving portion for accessing the above-mentioned distribution information based on the above-mentioned access information included in the distribution request received by the above-mentioned first receiving portion to receive this distribution information, and a distribution portion for specifying an address of a distribution destination terminal device based on the above-mentioned distribution destination information included in the distribution request received by the above-mentioned first receiving portion, and the terminal information stored in the above-mentioned first storage portion, and for distributing the distribution information received by the above-mentioned second receiving portion to the above-mentioned specified destination terminal device.

According to the third aspect of the present invention also, it is possible to achieve the same operational effects as the above-mentioned first aspect and second aspect of the present invention.

### BRIEF DESCRIPTION OF THE DRAWINGS

FIG. 1 is a block diagram showing the overall constitution of a telecommunications network system according to one embodiment of the present invention;

FIGS. 2A and 2B show the data structure of a terminal information database, and the contents thereof;

FIG. 3A is a flowchart showing the flow of overall processing by a terminal, and FIG. 3B is a flowchart showing the flow of overall processing by a management server;

FIG. 4 is a flowchart showing the flow of terminal registration processing of a terminal;

FIG. 5 is a flowchart showing the flow of information distribution processing of a terminal;

FIG. 6 is a flowchart showing the flow of information display/execution processing of a terminal;

FIG. 7 is a flowchart showing the flow of information marking processing of a terminal;

FIG. 8 is a flowchart showing the flow of terminal registration processing of a management server;

FIG. 9 is a flowchart showing the flow of information distribution processing of a management server;

FIG. 10 is a flowchart showing the flow of information marking processing of a management server;

FIG. 11 is a flowchart showing the flow of information conversion/filtering processing;

FIG. 12 is a sequence diagram showing the flow of terminal registration processing;

FIG. 13 is a sequence diagram showing the flow of information distribution processing;

FIG. 14 is a sequence diagram showing the flow of distribution processing for a competitive game program which is information to be shared;

FIG. 15 is a sequence diagram showing the flow of distribution of information to which a marking has been applied;

FIG. 16 is a sequence diagram showing the flow of information distribution processing for licensed software;

FIG. 17 is a sequence diagram showing the flow of processing for information distribution by combining an in-house server and a management server;

FIG. 18 is a sequence diagram showing the flow of processing for information distribution by combining an in-house server and a management server;

FIG. 19 is a sequence diagram showing the flow of processing for product information distribution;

FIG. 20A shows a terminal registration menu screen;

FIG. 20B shows a screen after registration of a terminal has been accepted;

FIGS. 21 and 22 show the application of a marking to map information displayed on a display portion of a terminal, and the flow of a series of display screens up until distribution;

FIG. 23A is an example of a screen for searching for product information displayed on a display portion of a terminal;

FIG. 23B is an example of a resultant screen for searching for product information;

FIG. 24A is an example of a screen for searching for product information;

FIG. 24B is an example of a screen showing retrieved product information;

FIG. 25A is an example of a screen for information distribution;

FIG. 25B is an example of a screen showing notification of information-sharing completion;

FIG. 26A is an example of a menu screen for searching for a product;

FIG. 26B is an example of a screen for an result of searching for a product;

FIG. 27A is an example of a menu screen for searching for a product;

FIG. 27B is displayed on the display portion of a terminal; and

FIG. 28 shows the data structure of the data transmitted and received.

### DESCRIPTION OF THE PREFERRED EMBODIMENTS

1. System Constitution

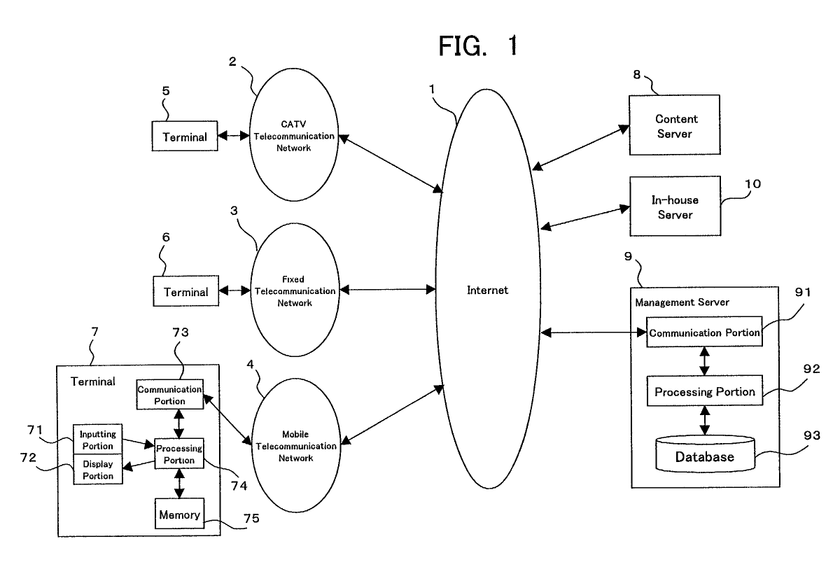

FIG. 1 is a block diagram showing the overall constitution of a telecommunications network system according to one embodiment of the present invention. This telecommunications network system has the Internet 1 as one example of a telecommunications network.

Connected to the Internet 1 are a content server 8 operated/managed by a content provider, which provides various information or services, a management server 9 for registering and managing a group registrant (user), the group of the registrant, and group members (users), and an in-house server 10, installed by an enterprise, such as a department store to store in-house information, which is to be used in-house.

Also connected to the Internet 1, are for example, a CATV telecommunications network 2, a fixed telecommunications network (for example, a telephone network) 3, and a mobile telecommunications network 4, as telecommunications networks which various telecommunications carriers operate/manage. Terminals 5-7, which users subscribing to each telecommunications carrier network utilize, are respectively connected to these different telecommunications carrier networks 2-4.

These terminals 5-7 are connected to the Internet 1 via the respective telecommunications carrier networks 2-4 to which users have subscribed, perform communications with management server 9 and content server 8 via the Internet 1, and can access various information and reference (peruse, view and listen to) information, and, in addition, be provided with services.

Terminals 5-7 (will be referred to generically hereinbelow as “terminal 7”; further, when distinguishing between two terminals, same will be referred to as “terminal A” and “terminal B”, and when distinguishing between three terminals, same will be referred to as “terminal A”, “terminal B” and “terminal C”) include a computer, cellular phone, and personal data assistant (PDA), and, in addition, a household appliance (for example, a television set) and an information terminal built into an automobile.

Terminal 7 comprises an inputting portion 71 (a keyboard, mouse, buttons, etc.), a display portion 72 (CRT display, liquid crystal display, or similar), communications portion 73, processing portion 74 and memory 75, as in the case of a computer which has communications functions.

Communications portion 73 carries out communications with other terminals 7, content server 8 and management server 9 via the respective telecommunications carrier networks 2-4 and the Internet 1. Processing portion 74 controls inputting portion 71, display portion 72, communications portion 73 and memory 75, and, in addition, processes data inputted from a user via inputting portion 71, and data inputted from communications portion 73, and either stores processing results in memory 75, and displays same on display portion 72, or transmits same to a telecommunications network 2-4 via communications portion 73 and to either management server 9 or content server 8 via the Internet 1.

Management server 9 comprises communications portion 91, processing portion 92, and database (storage device) 93. Communications portion 91 carries out communications with either terminal 7 or other servers, such as content server 8, via the Internet 1. Processing portion 92 controls communications portion 91 and database 93, and, in addition, performs terminal information registration, processing of information, and billing-by-proxy processing, which will be explained in detail hereinbelow. Database 93 stores terminal information, filtering information, and screen data, which is displayed on the display screen of terminal 7, such as a terminal menu screen (will be explained hereinbelow).

Content server 8 is a server for providing contents (information) to other servers and to user terminal 7 via the Internet 1. In FIG. 1, only one content server 8 is representatively shown, but a plurality of content servers 8 are connected to the Internet 1 for each item of information provided. The “contents” provided by content server 8 include programs (program products), product information, statistical data, weather information, maps and various other information, and these items of information are in various formats, such as textual data, program data, moving picture data, still picture data, sound data and so forth.

A subscription or the like is concluded beforehand between management server 9 and content server 8. In accordance therewith, it becomes possible for management server 9 to download requested information from content server 8 by transmitting a request for information to content server 8. However, when the information, with which management server 9 is provided, is chargeable, content server 8 accordingly bills (billing-by-proxy request, which will be explained hereinbelow), via management server 9, either the user (terminal 7), who ultimately received the information, or the telecommunications carrier of the telecommunications network 2-4 to which the user subscribes.

2. Overall Processing by Terminal and Management Server

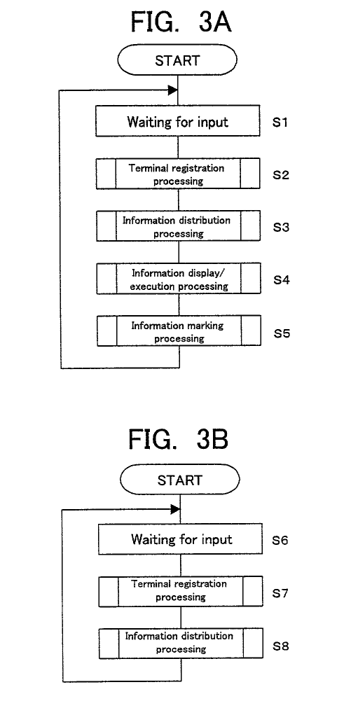

FIG. 3A is a flowchart showing the flow of overall processing by terminal 7, and FIG. 3B is a flowchart showing the flow of overall processing by management server 9.

Terminal 7 is initially in a state of waiting for input from either a user or a telecommunications network 23 (S1). When either an input is made to the inputting portion 71 by a user, or an input is made to the communications portion 73 from a telecommunications network 2-3, processing portion 74 proceeds with terminal registration processing (S2), information distribution processing (S3), information display/execution processing (Step S4), and information marking processing (S5) in accordance with this input. Details concerning this terminal registration processing (S2), information distribution processing (S3), information display/execution processing (S4), and information marking processing (S5) will be explained below.

Meanwhile, management server 9 is initially in a state of waiting for communications data input from the Internet 1 (S6). When there is an input of communications data to the communications portion 91 from the Internet 1, processing portion 92 analyzes this input, and proceeds with terminal registration processing (S7) and information distribution processing (S8). Details concerning this terminal registration processing (S7) and information distribution processing (S8) will be explained below.

3. Terminal Registration Processing

The terminal registration processing of Step S2 of FIG. 3A and Step S7 of FIG. 3B will now be explained.

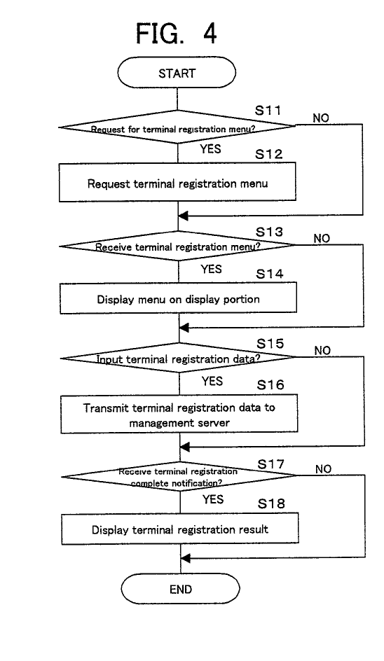

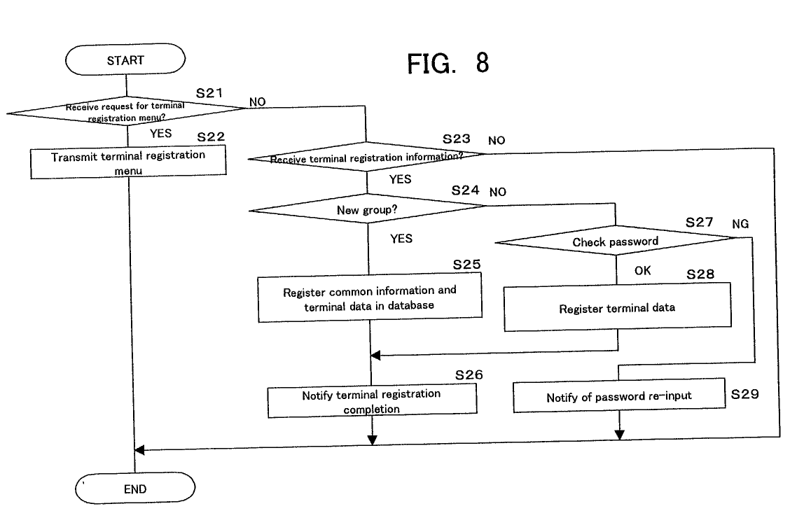

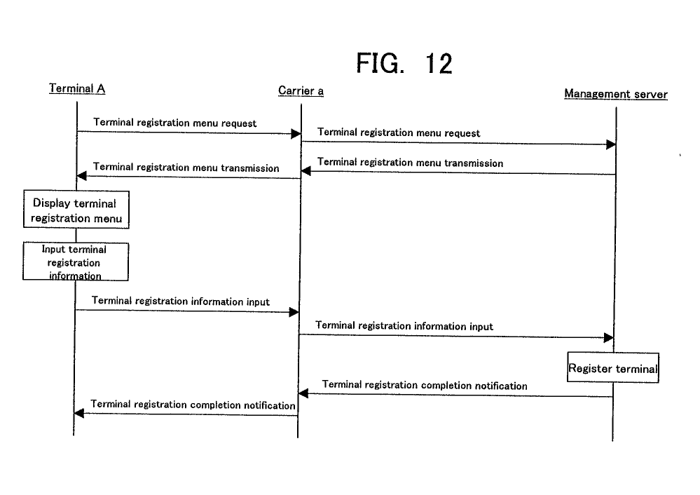

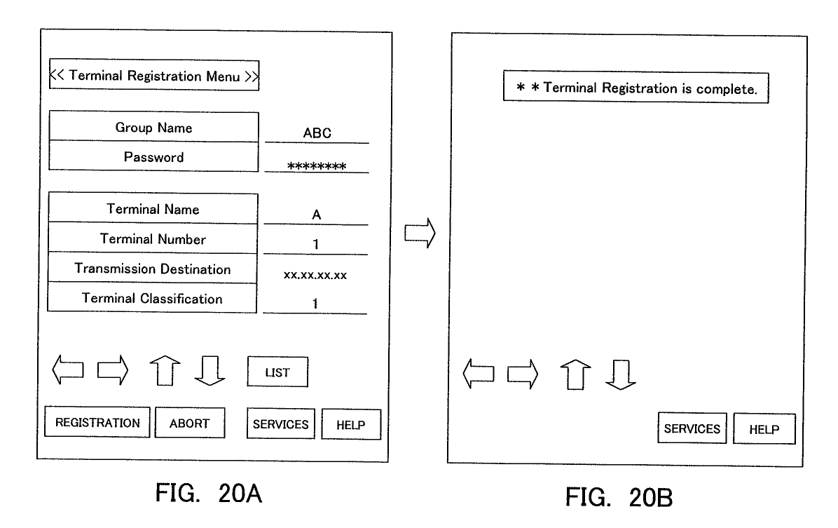

FIG. 12 is a sequence diagram showing the flow of terminal registration processing. FIG. 4 is a flowchart showing the flow of terminal registration processing of the terminal 7 (terminal A), and FIG. 8 is a flowchart showing the flow of terminal registration processing of the management server 9. FIG. 20 is an example of a terminal registration screen, which is displayed on display portion 72 of terminal 7, FIG. 20A shows a terminal registration menu screen, and FIG. 20B shows a screen after registration of a terminal has been accepted.

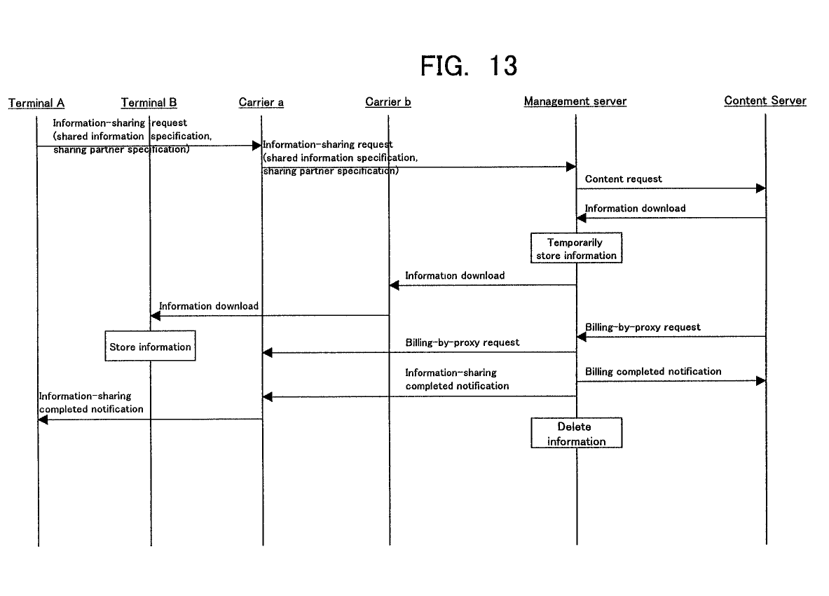

Furthermore, in the sequence diagram of FIG. 12, “carrier a” signifies either a telecommunications network 2-4 of a telecommunications carrier to which terminal A subscribes, or a telecommunications carrier (managing/operating company) to which terminal A subscribes. That is, a case in which communications data is relayed between terminal A and either management server 9 or content server 8 signifies a telecommunications network 2-4, and a case in which a billing-by-proxy request is performed, as will be explained hereinbelow, signifies a telecommunications carrier. Further, the Internet 1 has been omitted in order to simplify the figure. The same holds true for the sequence diagrams of FIG. 13 through FIG. 19.

Terminal A makes a determination as to whether or not an input from a registrant (user) to inputting portion 71 is a request for a terminal registration menu (S11), and when the input is a request for a terminal registration menu (YES in S11), terminal A requests a terminal registration menu from management server 9. Either the IP (Internet Protocol) address or URL of management server 9, which is required in order to request a terminal registration menu from management server 9, can be inputted into terminal 7 by a registrant, or, when stored in memory 75 beforehand, the stored IP address or URL can be used.

Management server 9, in response to a request for a terminal registration menu, transmits a terminal registration menu to terminal A (S21, S22). When terminal A receives the terminal registration menu (YES in S13), the terminal registration menu shown in FIG. 20A is displayed on display portion 72 of terminal A (S14).

When a registrant uses a terminal registration menu to input terminal registration information via inputting portion 71 of terminal A (YES in S15), terminal A transmits the inputted terminal registration information to management server 9 (S16).

A group name, password, and terminal data (terminal name, terminal number, transmission destination, and terminal classification) are included in the inputted terminal registration information. Terminal data is inputted for each member terminal belonging to the group. For example, when there are three members, three sets of terminal data are inputted.

The “terminal name” included in terminal data is a registrant-assigned terminal 7 name. Either an IP address or a telephone number of a transmission destination terminal for shared information, which will be explained hereinbelow, is used for the “transmission destination”. The “terminal number” is a number for identifying each terminal within the group. “Terminal classification” denotes a type of terminal, which is classified according to the format of the information (image data, textual data, and so forth) which display portion 72 of terminal 7 is capable of displaying. The integers 0, 1, 2, and 3 are used as such terminal classifications in this aspect of the embodiment. The presence of distribution information conversion/filtering is determined based on the numerals of these terminal classifications. The conversion/filtering thereof will be explained in detail below.

When management server 9 receives terminal registration information from terminal A (YES in S23), management server 9 checks the terminal registration information, and registers this information in a terminal information database within database 93.

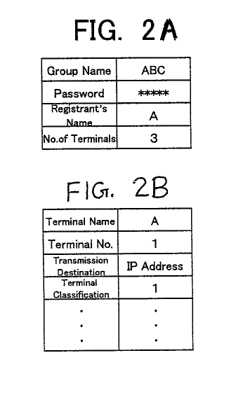

FIGS. 2A and 2B show the data structure of a terminal information database, and the contents thereof. The terminal information database has common data (FIG. 2A) and terminal data (FIG. 2B).

Common data is constituted from an information-sharing group name (ABC), a password (a non-display mark “*****”), a registrant's name (A), and the number of terminals (3), which belong to the group. Here, a registrant inputs the group name and password into a registration menu. The name of a registrant, for example, a name registered beforehand in registrant terminal A is incorporated into the terminal registration information, and transmitted to management server 9 from terminal A. The number of inputted terminal data items is counted by either terminal A or management server 9, which permits the number of terminals to be registered. Terminal data is inputted in the above-mentioned terminal menu, and is provided for the number of terminals belonging to a group.

The actual registration process for terminal registration information in management server 9 is performed as follows. Firstly, a determination is made as to whether or not a registered group is a new group (S24). In the case of a new group (YES in S24), common information and terminal data are registered in the terminal information database. When the group is not new (NO in S24), the inputted password is checked (S27).

When the password is correct (OK in S27), terminal data is registered in the terminal information database (S25), and thereafter, terminal A is notified that terminal registration is complete (S26), and at terminal A, the screen shown in FIG. 20B is displayed on display portion 72 (S18). When the password is not correct (NG in S27), terminal A is requested to re-input the password (S29), and processing is repeated once again from Step S21.

A group is thus registered in database 93 of management server 9.

Furthermore, in the flowchart of FIG. 4, when all the decision blocks (S11, S13, S15, S17) are “NO,” terminal A processing proceeds to the information distribution processing of Step S3 of FIG. 3A without performing terminal registration processing. Similarly, in the flowchart of FIG. 8, when decision blocks S21 and S23 are also both “NO,” management server 9 processing proceeds to information distribution processing of Step S8 shown in FIG. 3B.

Further, two or more registrants can be in one group, and there are cases in which the same registrant becomes a registrant in two or more groups. Furthermore, there are also cases in which a certain member becomes a member of two or more groups.

4. Information Distribution Processing

Information distribution processing of Steps S3 and S4 of FIG. 3A, and Step S8 of FIG. 3B will now be explained.

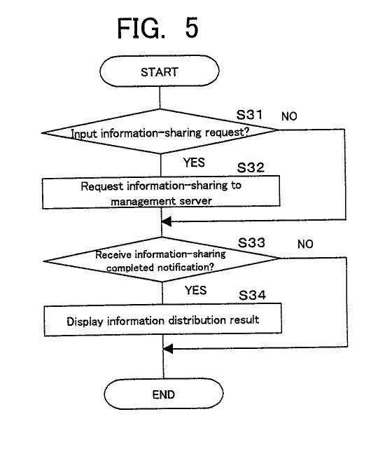

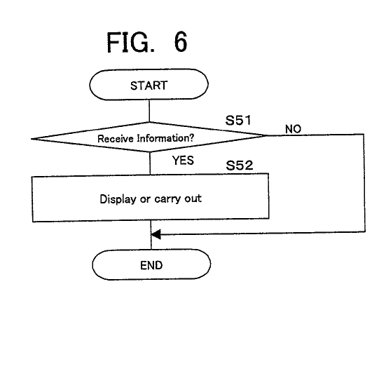

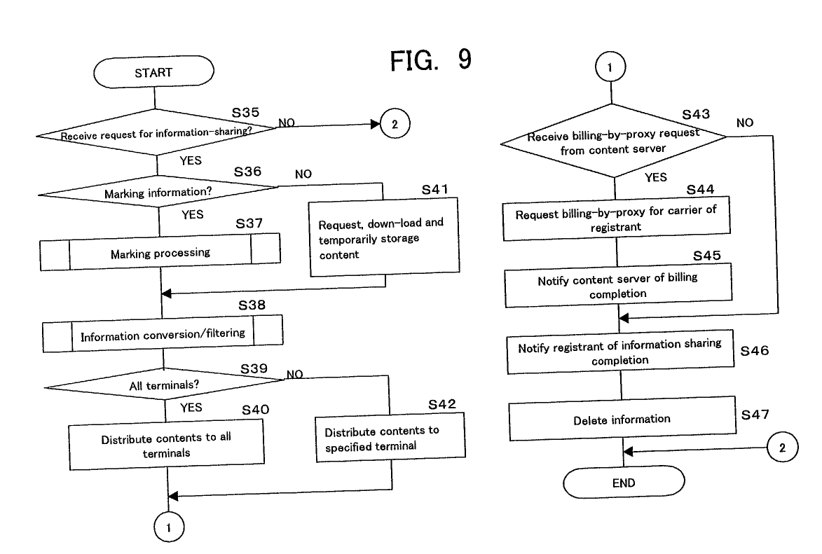

FIG. 13 is a sequence diagram showing the flow of information distribution processing. FIG. 5 is a flowchart showing the flow of information distribution processing (that is, the detailed processing of Step S3 of FIG. 3A) of terminal 7 (terminals A and B). FIG. 6 is a flowchart showing the flow of information display/execution processing (that is, the detailed processing of Step S4 of FIG. 3A, of the terminal 7 (especially terminal B). FIG. 9 is a flowchart showing the flow of information distribution processing (that is, the detailed processing of Step S8 of FIG. 3B) of the management server 9.

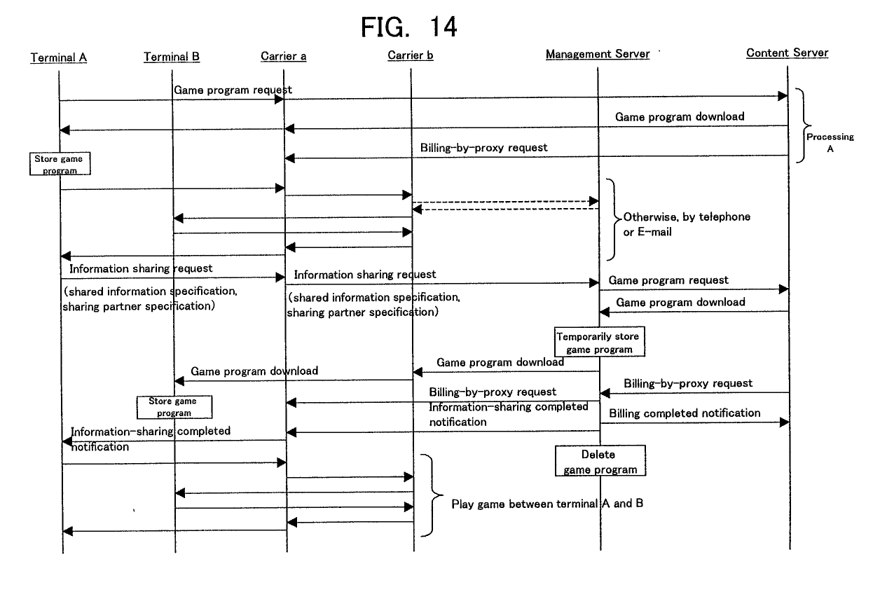

Furthermore, in the sequence diagram of FIG. 13, terminal B is the terminal receiving information distribution. Further, carrier b is the carrier to which terminal B subscribes, and is used in the same sense as the above-mentioned carrier a. The same also holds true for FIG. 14 through FIG. 19.

When the above-mentioned registrant wants to share information, which he himself holds, with a member of his own group, this registrant inputs the group name, password, the information he wants to share (information to be shared), and the sharing partner (group member), to inputting portion 71 of terminal A, and transmits an information-sharing request to management server 9 (YES in S31, S32).

The group name and password are used for authentication. A URL (Uniform Resource Locator) showing, for example, the storage location of information targeted for sharing is used in specifying information to be shared. Further, in specifying a sharing partner, for example, either the terminal number of a member who is a sharing partner (sharing destination terminal number) or a group name is used. The terminal numbers of all the members of a group (excluding the registrant) can be inputted, or the terminal numbers of only some of the members of the group can be inputted. Further, when a group name is specified, all the members of the group (excluding the registrant) are specified.

Terminal A transmits an information-sharing request, and, in addition, the URL and terminal numbers to management server 9.

When management server 9 receives an information-sharing request (YES in S35), a determination (S36) is made as to whether or not the received information-sharing request is marking information (will be explained below). When it is not marking information (NO in S36), the management server 9 requests the information to be shared from content server 8, downloads same from content server 8, and, in addition, temporarily stores this information (S41).

Thereafter, management server 9 performs filtering (S38) when information filtering processing (will be explained below) is required, and distributes the information downloaded from content server 8 to a sharing destination terminal B (either all the terminals or some terminals of a group) via carrier b (and the Internet 1) (S39-S41).

When distributed information is received by communications portion 73 of terminal B, processing in terminal B proceeds from Step S1 to Step S2 in the flowchart shown in FIG. 3A. Here, because decision blocks S11, S13, S15 and S-17 in Step S2 processing (FIG. 4) are all “NO”, processing advances to Step S3. In Step S3, as shown in FIG. 6, distributed information is either displayed on display portion 72 according to the contents of the information, or is executed by processing portion 74 (S51, S52). For example, when the distributed information is still image data, this still image data is displayed on display portion 72, and when the distribution information is a game program, this game program is executed by processing portion 74.

Next, a billing-by-proxy request including a bill of charges is sent from content server 8 to management server 9. Here, a “billing-by-proxy request” is a request to allow management server 9 (and carrier a, to which the registrant subscribes) to serve as an agent for collecting a fee for information provided by content server 8 without content server 8 collecting this fee from terminal A (that is, the registrant). Since a bill of charges such as this is ordinarily paid by carrier a, to which the registrant subscribes, management server 9 bills the charges to carrier a (S43, S44).

By using a billing completed notification, management server 9 notifies content server 8, of the fact that the bill of charges was changed (shifted) to the registrant (carrier a) (S46).

Next, management server 9 transmits, to terminal A via carrier a (and the Internet 1), an information-sharing completed notification indicating that the information to be shared was received by terminal B, and information-sharing has been completed (S46). When terminal A receives an information-sharing completed notification (YES in S33), terminal A displays information distribution results on display portion 72 (S34). Meanwhile, management server 9 deletes the information to be shared, which had been stored temporarily (S47).

4.1. Competitive Game Information Distribution

As a specific example of the above-mentioned information distribution, the distribution of competitive game information (that is, a competitive game program) will now be explained. The distribution of such a competitive game program is performed when, for example, a registrant downloads, from content server 8, the latest chargeable competitive game (game program), which can be enjoyed on terminal 7, but when the terminal 7 of another user, who is an opponent, does not have the same competitive game.

FIG. 14 is a sequence diagram showing the flow of distribution processing for a competitive game program which is information to be shared.

The processing A initially performed in FIG. 14 (a game program request from terminal A to content server 8, in which the game program is stored, game program download from content server 8 to terminal A, and billing-by-proxy request from content server 8 to carrier a) involves a registrant (terminal A user) directly accessing content server 8 and downloading a game program.

Either before or after this processing A, the registrant, using terminal A, either pre-registers a plurality of associates, such as friends, as group members by means of the above-mentioned terminal registration processing, or registers same each time. Furthermore, in this specific example, a single registrant is used to simplify the explanation. Terminal information of terminal B of the game opponent is thus registered in the terminal information database of management server 9.

After registration, the registrant, uses terminal A to make a request to management server 9 to send terminal B a notification to the effect that the registrant wants to play a competitive game. In response to this request, management server 9 transmits the notification from the registrant to terminal B. Thereafter, an agreement is made between terminal A (the registrant) and terminal B (the opponent) to play a competitive game. Furthermore, this notification and agreement between terminal A and terminal B can also be achieved by both parties conversing by telephone, or communicating by electronic mail, without going through management server 9.

When an agreement has been made, the registrant uses terminal A to transmit an information-sharing request to management server 9 together with an information to be shared specification (game program URL) and a sharing partner specification (terminal number of terminal B).

Management server 9 requests a game program from content server 8 based on the URL transmitted from terminal A, and content server 8, in response to this request, downloads a game program to management server 9.

Management server 9 temporarily stores the game program provided from content server 8, and, in addition, downloads this game program to terminal B. Terminal B then stores the downloaded game program.

Meanwhile, content server 8 transmits a request for collection of payment for game program downloading to registrant-subscribed carrier a, via management server 9. That is, the registrant, who is the user of terminal A, bears the cost of downloading a game program to terminal B.

Thereafter, management server 9 transmits a billing completed notification to content server 8, and, in addition, transmits an information-sharing completed notification to terminal A. The registrant thus knows that a game program has been downloaded to terminal B. It thus becomes possible for the registrant and the user of terminal B to use terminals A and B, respectively, to play a game via carriers a and b.

Management server 9 deletes a temporarily stored game program after transmitting an information-sharing completed notification.

Thus, a registrant can invite a group member, such as a friend, to play a game, without the friend or other member being made to bear the costs for the information (game program). Further, it is possible for a registrant to simply send an information-sharing request after registering a member terminal 7, and to have management server 9 carry out the action intended by the registrant, without performing a complicated operation from terminal 7.

Hereinabove, an explanation is given using a competitive game as an example, but it is also possible to share information such as music, images and so forth, in addition to competitive games. Further, it is also possible for members to easily perform information sharing by a registrant registering a plurality of members. 4.2. Distribution of Information With Markings As an example of “additional information,” information, to which markings and/or comments have been added, can also be distributed and shared with members of a group. By way of example, processing will now be explained that involves applying a marking to distributed map information (for example, the addition of a symbol to mark a meeting place, or the like), and, in addition, adding a comment regarding the time of the meeting and so forth, and distributing same to members of a group.

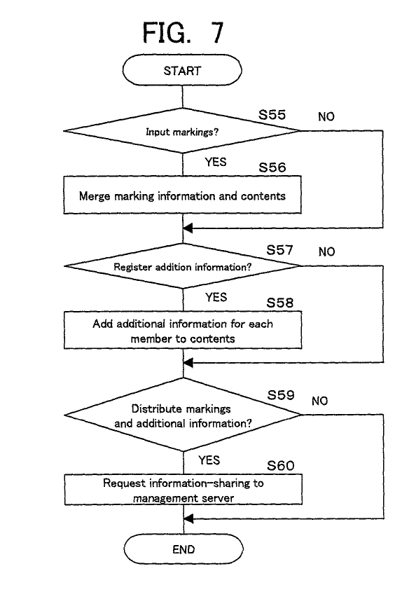

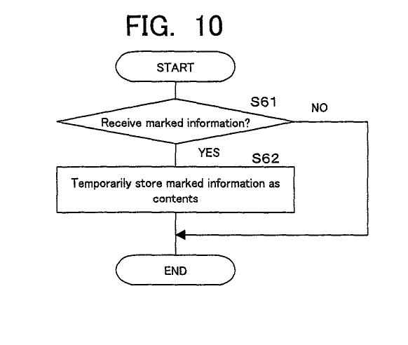

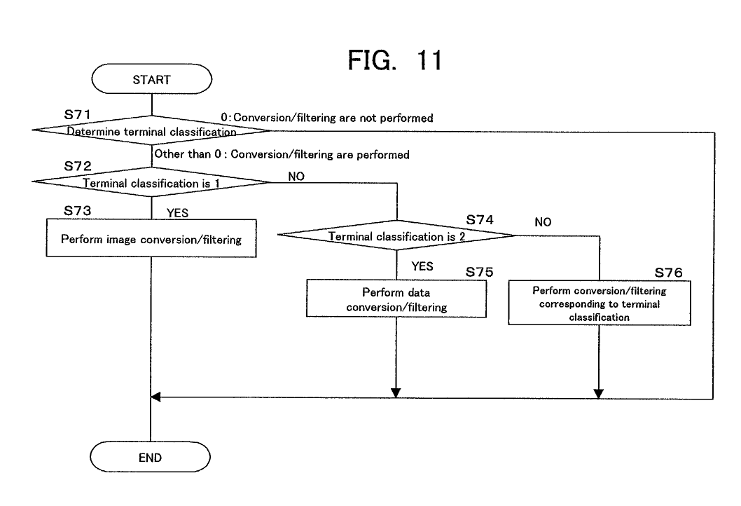

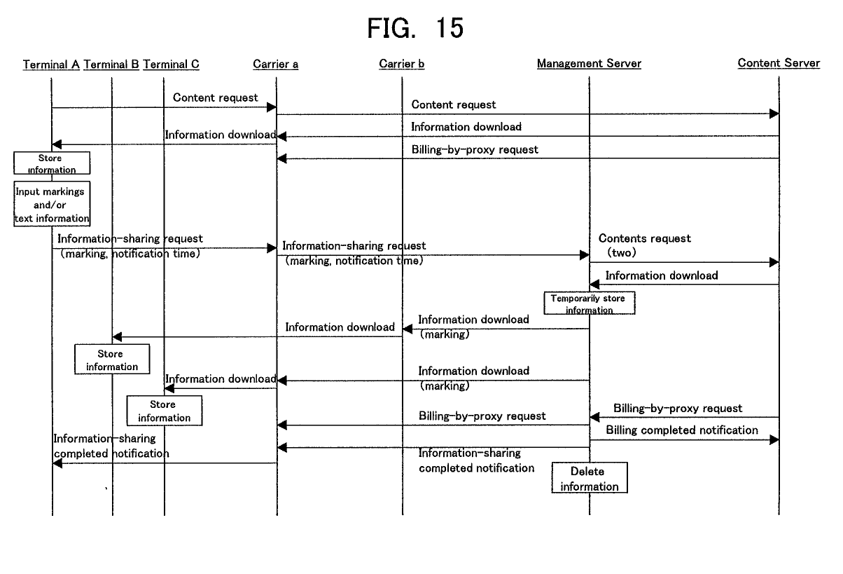

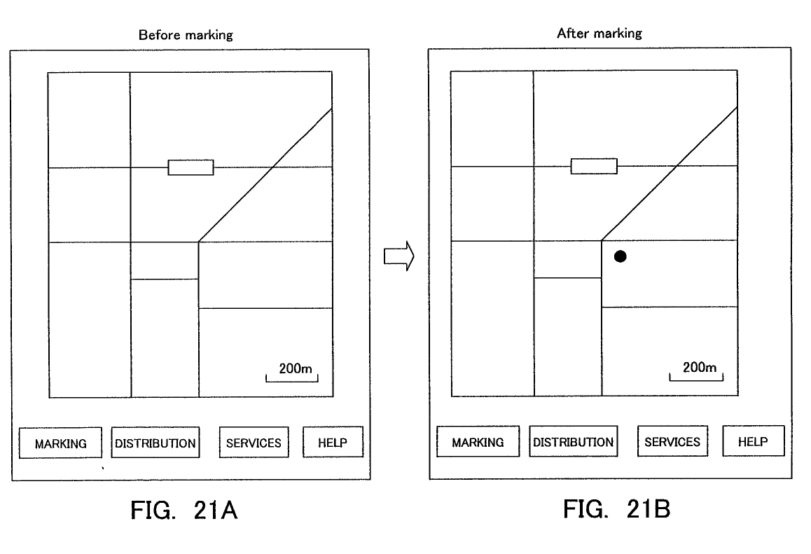

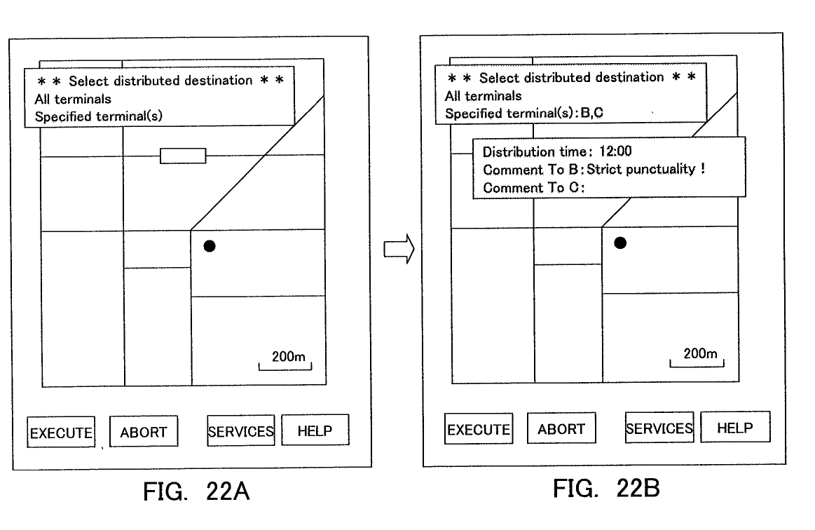

FIG. 15 is a sequence diagram showing the flow of distribution of information to which a marking has been applied. FIG. 7 is a flowchart showing the flow of information marking processing (that is, the detailed processing of Step S5 of FIG. 3A) of the terminal 7 (terminals A, B and C). FIG. 10 is a flowchart showing the flow of information marking processing of the management server 9 (that is, the detailed processing of Step S37 of FIG. 9). FIG. 11 is a flowchart showing the flow of information conversion/filtering processing (that is, the detailed processing of Step S38 of FIG. 9). FIG. 21 and FIG. 22 show the application of a marking to map information displayed on display portion 72 of terminal 7, and the flow of a series of display screens up until distribution.

A registrant uses terminal A to either pre-register a plurality of associates, such as friends, as group members, in management server 9 or register same each time immediately prior to information distribution. Here, it is supposed that two members have been registered by a registrant, and it is supposed that the terminals used thereby are terminals B and C, respectively.

The registrant, in order to inform the two members of a meeting place, uses terminal A to make a direct request for content to content server 8 for chargeable map information, and downloads the map information from content 5 server 8. Thereafter, a billing-by-proxy request is transmitted to carrier a from content server 8.

The downloaded map information is stored in terminal A, and is displayed on display portion 72 of terminal A by means of the information display/execution processing of Step S4 of FIG. 3 (Step S52 of FIG. 6). FIG. 21A shows an example of map information being displayed on display portion 72.

A registrant can apply a marking to the downloaded map information, such as the black dot shown in FIG. 21B, by operating inputting portion 71 of terminal A. This marking is made by selecting (clicking) the “Mark” button in the lower left portion of the display screen shown in FIGS. 21A and 21B, and, thereafter, specifying the place one wants to apply the marking using a pointer, cursor, or the like (S55). When the marking is applied (YES in S55), the marking information and map information are merged (S56), and a black dot like that shown in FIG. 21B is displayed in the specified location.

Thereafter, when the “Distribute” button in the lower portion of the display screen is selected by a registrant, a “Select Distribution Destination” dialog box is displayed as shown in FIG. 22A. It is possible to select either “Distribute to All Terminals” for distribution to all registered group terminals, or “Distribute to Specified Terminals” for distribution to only a number of specified terminals. Here, as shown in FIG. 22B, “Distribute to Specified Terminals” is selected, and terminals B and C are inputted as the specified terminals.

Next, when the “Service” button in the lower portion of the display screen is selected, a dialog box for inputting distribution time and a comment to each distribution destination terminal is displayed. For “Distribution Time,” the time at which the map information is to be transmitted to the specified distribution destination terminals (here, terminals B and C) can be inputted. When a distribution time is specified, management server 9 transmits the map information, marking information, and comments to terminals B and C at the specified distribution time. Conversely, it is also possible not to input anything in the “Distribution Time” field, in which case, management server 9 transmits the map information, marking information, and comments to terminals B and C immediately after receiving an information-sharing request from terminal A.

The fact that distribution time can be specified in this way distinguishes the invention from conventional broadcast communications in which information is transmitted to destination terminals immediately following distribution. Further, as will be explained below, the invention is also distinguished from conventional broadcast communications by the fact that management server 9 edits terminal A-specified marking information and chargeable content (here, map information), which management server 9 acquires from content server 8 for terminal B and terminal C, and transmits this edited information to terminal B and terminal C, and, in addition, that management server 9 makes terminal A pay the acquisition costs of the chargeable content.

Further, it is possible to input a comment, for each distribution destination terminal, in this dialog box. In FIG. 22B, the comment “Be sure to be on time!” is added for terminal B. Other comments besides this can be added individually for each member, such as, for example, information, such as an earlier meeting time for making preparations, preparation items, or the like, or a request to member C can be inputted not to prepare the same items as member B, and the like.

When the “Execute” button at the bottom portion of the display screen is selected by the registrant (YES in S59), terminal A transmits (S60) an information-sharing request to management server 9, together with a marking and comment (textual data), as well as a notification time specification.

Management server 9, having received the information-sharing request from terminal A, requests two items of map information from content server 8. Content server 8, in response to this request, downloads two items of map information to management server 9.

Management server 9 temporarily stores the map information, and, in addition, transmits this map information, as well as a marking and comment, to terminals B and C at the specified time. In the above-mentioned example of FIG. 22B, since a comment has been inputted for terminal B only, a comment is sent only to terminal B.

Further, at the transmitting time thereof, management server 9, as shown in the flowchart of FIG. 11, also carries out the processing of the information to be distributed (executes conversion and/or filtering in accordance with a terminal classification) according to the terminal classifications of terminals B and C. In this aspect of the embodiment, destination terminal classifications used are numerals 0, 1, 2 and 3, as mentioned hereinabove.

Terminal classification 0 is assigned to a terminal capable of displaying a variety of distribution information. Consequently, conversion/filtering are not performed for information to be distributed to a terminal having terminal classification 0 (0 in S71).

Conversely, for terminals of terminal classifications other than 0, information conversion/filtering is performed (other than 0 in S71). For example, image conversion/filtering (for example, conversion from the JPEG format to a bitmap format, and the enlargement/reduction/deletion of information according to the size of a display screen) is performed (S73) for information to be distributed to a terminal of terminal classification 1. Further, data conversion/filtering (for example, the conversion of a language from XML (extensible Markup Language) to HTML or the like) is performed (S74, S75) for information to be distributed to a terminal of terminal classification 2. Terminal classification-dependent converting/filtering (for example, the deleting (filtering) of characters, images and so forth that cannot be displayed) is performed (S76) for information to be distributed to a terminal of terminal classification 3. Map information is transmitted to the terminals subsequent to this processing.

After downloading the map information to management server 9, content server 8 transmits a payment request to carrier a via management server 9, and management server 9 transmits a billing completed notification to content server 8.

Subsequent to map information distribution, management server 9 deletes, from terminal A, the map information, marking information, and textual information, which was being stored temporarily.

Thus, by a registrant registering the members of a group, the registrant can communicate the intended information at the intended time without performing a complicated operation from the terminal and without knowing the terminal attributes of the group members. Further, by attaching a marking to the information, the information can be made easier for a user to distinguish. Furthermore, by adding a comment to the information, it is possible to heighten the added value of information sharing.

In a mobile environment in particular, terminal operability is an issue. By management server 9 carrying out the intentions of a registrant, as is the case with this service, information-sharing can easily be performed among the members of a group.

Furthermore, when the map information is free-of-charge, a billing-by-proxy request is not transmitted from content server 8 and management server 9, and a billing completed notification is not transmitted from management server 9.

Further, it is also possible to transmit, to group members, information, where marking information and textual information have been added by the registrant to a map by hand. In this case, map information, to which marking information and textual information have been added, is transmitted to management server 9 from terminal A, and is then transmitted to terminals B and C from management server 9.

4.3. Distribution of Licensed Software

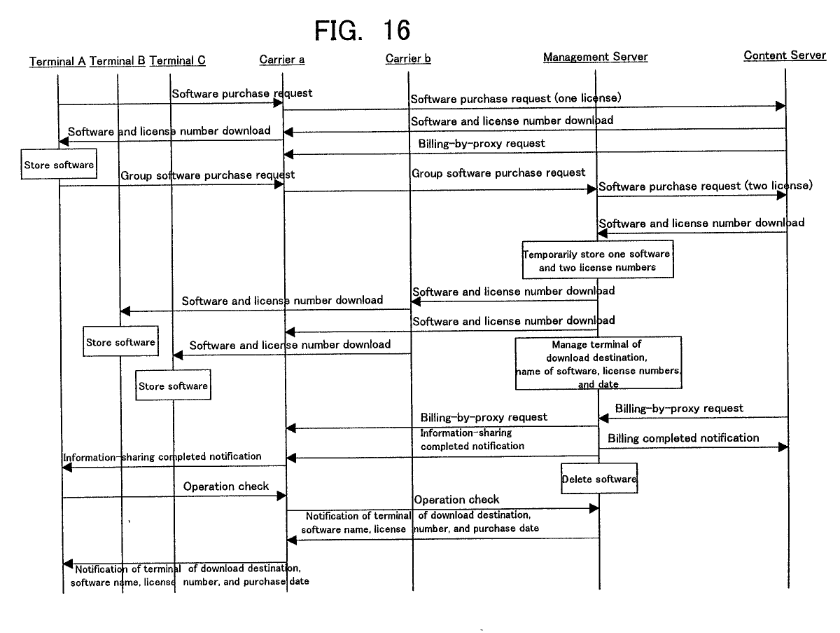

As another specific example of information distribution, the distribution of licensed software will be explained. FIG. 16 is a sequence diagram showing the flow of information distribution processing for licensed software.

The user of terminal A makes himself the registrant, and, using terminal A, either registers software distribution destination terminals (here, terminals B and C) as group members beforehand by means of the above-mentioned terminal registration processing, or performs this registration immediately prior to distribution each time.

Either before or after registering group members, the registrant uses terminal A to transmit a software purchase request (only one license for the registrant alone), together with the name (or identifier) of the software to be purchased, to content server 8, which provides licensed software.

Upon receiving the software purchase request, content server 8 downloads the software and license number to terminal A, and thereafter, transmits a billing-by-proxy request to carrier a. A software license is thus granted to the registrant, and the purchased software is downloaded to terminal A.

Thereafter, the registrant uses terminal A to transmit a group software purchase request as an information-sharing request to management server 9 in order to purchase the software for members in the group. This group software purchase request includes the name (or identifier) of the downloaded software, the URL of the software purchase request destination, instructions to grant two licenses, and the terminal numbers of the software download destination (the numbers of terminals B and C).

Management server 9 accesses content server 8 based on the URL transmitted from terminal A, and requests the software download denoted by the software name, and the granting of two licenses.

In response to this request, content server 8 downloads the software and two license numbers to management server 9. Management server 9 receives the software and two license numbers from content server 8, downloads the software to the two terminals B and C, and transmits one each of the two license numbers to terminals B and C, respectively. The software and the licenses therefor are thus supplied to terminals B and C, and the group members, who are the users of terminals B and C, are able to utilize the downloaded software in terminals B and C.

After downloading the software and license numbers, management server 9 stores and manages the terminal numbers of the download destinations (B and C), the name of the software, the license numbers, and the date of purchase, in database 93.

After downloading the software, content server 8 transmits a billing-by-proxy request to management server 9, and management server 9 sends this request to carrier a, and, in addition, transmits a billing completed notification to content server 8. Thus, the fact that the registrant is the purchaser of the software is communicated to content server 8.

Thereafter, management server 9 transmits an information-sharing completed notification to terminal A. This information-sharing completed notification also includes the respective license numbers transmitted to terminals B and C. The license numbers and the fact that the software can be utilized also at terminals B and C, are thus communicated to the registrant.

Next, management server 9 deletes the software downloaded from content server 8.

Thus, a registrant can allow the users of terminals B and C to utilize the software without making them bear the communications charges and the cost of purchasing the software. A registrant may simply register terminal users to utilize this service, and without performing a complicated operation from the terminal, a registrant can cause management server 9 to carry out an intended action on his behalf.

Further, because a registrant purchases the software license, there is no need to access content server 8 numerous times to download the software. Furthermore, since a registrant can cause management server 9 to manage the purchased software and license numbers, and the distribution destination terminals thereof, and can receive this information when necessary, the registrant can also operate and manage the software.

4.4. Information Distribution 1 for Sales Support by a Department Store, or the Like

Information distribution can also be performed by installing an in-house server (comprising a database system) 10 to provide content inside an enterprise, and combining this in-house server 10 with management server 9.

Here, it is supposed that the enterprise having in-house server 10 is a department store, and that in-house server 10 is a server having the product information of the department store. Further, it is supposed that content server 8 is a server having product information.

An example is provided hereinbelow in which, in response to a product inquiry from a customer, when the product information that the customer inquired about is not contained in the in-house server 10 (database), management server 9 performs information provision on behalf of in-house server 10.

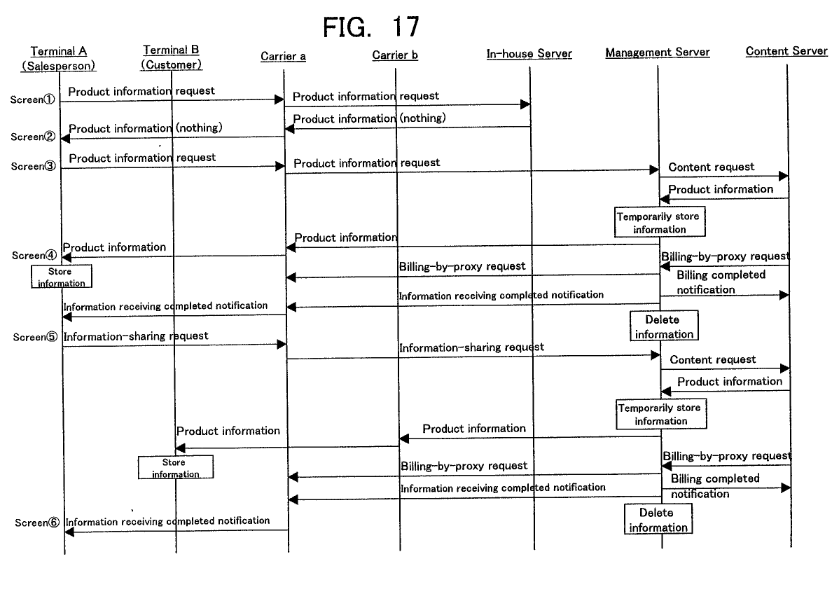

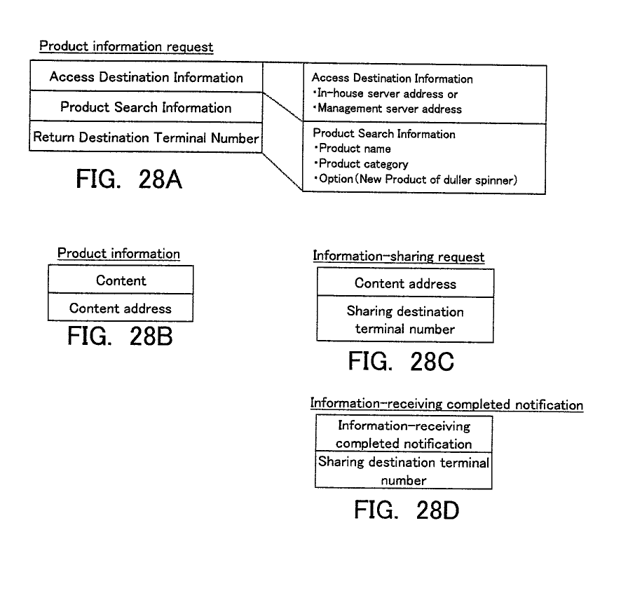

FIG. 17 is a sequence diagram showing the flow of processing for information distribution by combining in-house server 10 and management server 9. FIG. 28 shows the data structure of the data transmitted and received.

Supposing that an inquiry was made from a customer regarding a product while a salesperson and the customer A are having a conversation. Since the salesperson is unable to answer this inquiry from his own knowledge, the salesperson uses terminal 7 (terminal A) to access in-house server 10, and attempts a search for this product information.

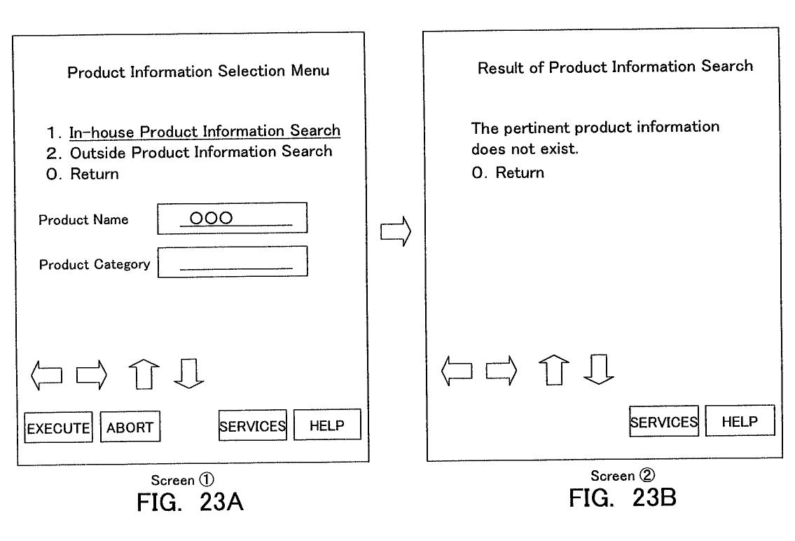

FIG. 23A is an example of a screen for searching for product information displayed on display portion 72 of terminal A. In this product information search screen, when “1. In-house Product Information Search” is selected, and, in addition, the name of the product to be searched for and the name of the product category, when there is a product category, are inputted, and the execute button in the bottom portion of the display screen is selected, a product information request (FIG. 28A) including the product name (and product category) is transmitted to in-house server 10 from terminal A, and a search is executed in in-house server 10.

When product information for an inputted product name is not found in in-house server 10, in-house server 10 notifies terminal A that the pertinent product information does not exist. The product information search results shown in FIG. 23B are displayed on display portion 72 of terminal A.

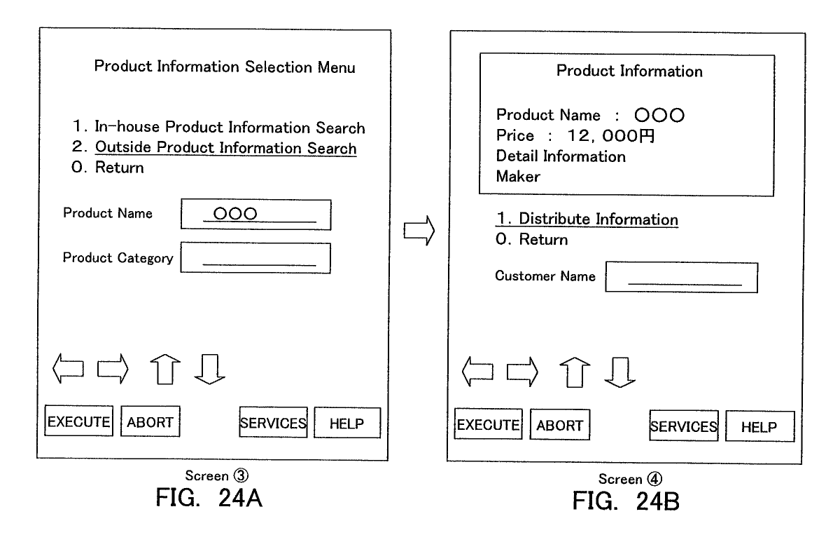

In this case, the salesperson treats the customer as a member of the group, and registers the customer's terminal in management server 9. Thereafter, the salesperson attempts to acquire the product information by accessing management server 9. FIG. 24A is an example of a screen for searching for product information when an outside product information search is specified. When “2. Outside Product Information Search” is selected, and, in addition, the name of the product (and the product category) is inputted, and the execute button is selected, a product information request (FIG. 28A) including the product name (and product category) is transmitted to management server 9 from terminal A.

When the product information request is received from terminal A, management server 9 accesses either one or two, or more, content servers 8 having product information, and downloads the pertinent product information and a URL for accessing this product information (FIG. 28B). The downloaded product information and URL are stored temporarily in management server 9, and, in addition, are transmitted to terminal A from management server 9. FIG. 24B is an example of a screen showing retrieved product information.

Upon receiving a billing-by-proxy request from content server 8, management server 9 transmits a billing-by-proxy request to carrier a, and transmits a change-of-billing notification to content server 8. Further, management server 9 transmits an information reception completed notification (FIG. 28D) to terminal A.

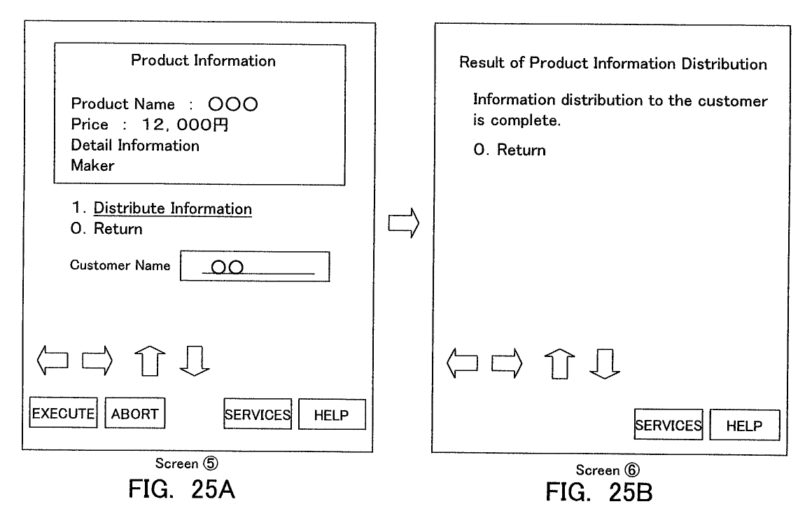

After confirming the product information via display portion 72 of terminal A, the salesperson selects “1. Information Distribution,” as shown in FIG. 25A, and, in addition, inputs information (a name and so forth) specifying the customer, in the customer name input field, and selects the execute button. An information-sharing request (FIG. 28C) is thus transmitted from terminal A to management server 9. The URL transmitted from management server 9, and a sharing destination terminal number (customer's terminal B) are included in the information-sharing request.

Management server 9 accesses the product information of content server 8 based on the URL included in the information-sharing request, downloads the product information, and temporarily stores the product information. Thereafter, management server 9 downloads the product information to customer terminal B.

Thereafter, content server 8 transmits a billing-by-proxy request to management server 9. Management server 9 transmits a billing-by-proxy request to carrier a, and, in addition, transmits a change-of-billing notification to content server 8. Then, management server 9 transmits an information-sharing completed notification (FIG. 28D) to terminal A to indicate that the information has been shared with the customer, and the screen shown in FIG. 25B is displayed on display portion 72 of terminal A.

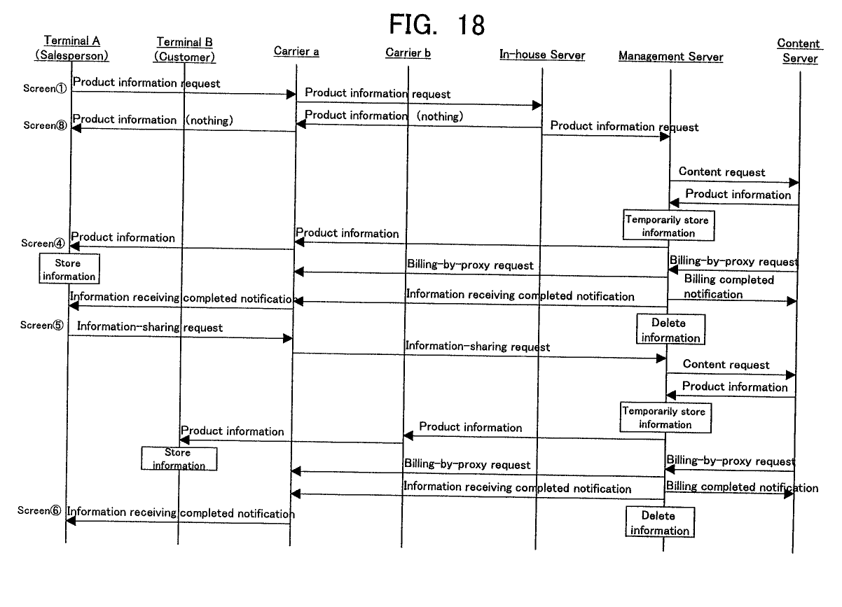

For the above-mentioned distribution of product information, when product information did not exist in in-house server 10, the salesperson uses terminal A to access management server 9, and attempts to acquire the product information, but when product information does not exist in in-house server 10, in-house server 10 can also be constituted so as to acquire the product information by directly accessing management server 9. FIG. 18 is a sequence diagram showing the flow of processing in this case. With the exception of the fact that in-house server 10 acquires product information by accessing management server 9 directly, since FIG. 18 is the same as FIG. 17, an explanation thereof will be omitted here.

4.5. Information Distribution 2 for Sales Support by a Department Store or the Like

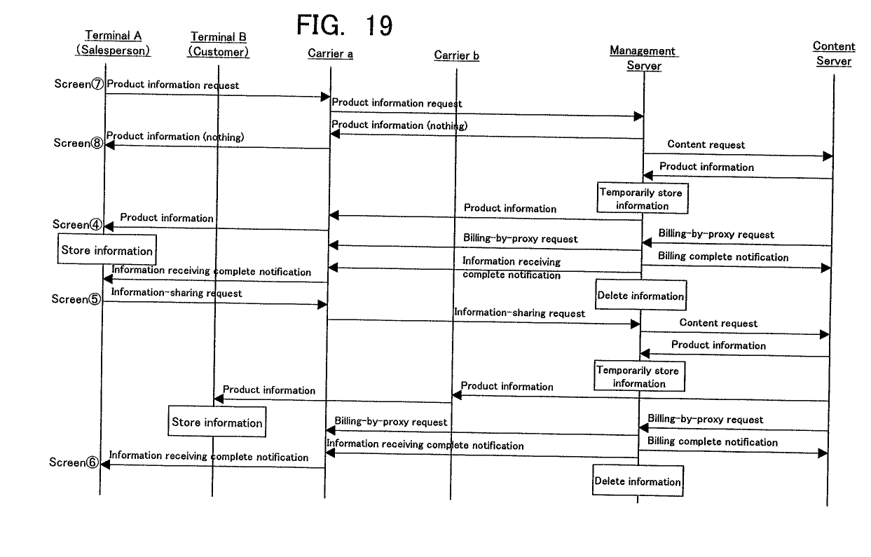

In the case of an enterprise that does not have an in-house server 10, processing can also be performed as in the sequence shown in FIG. 19.

Supposing that in-house product information and customer information are stored beforehand in database 93, which resides in management server 9.

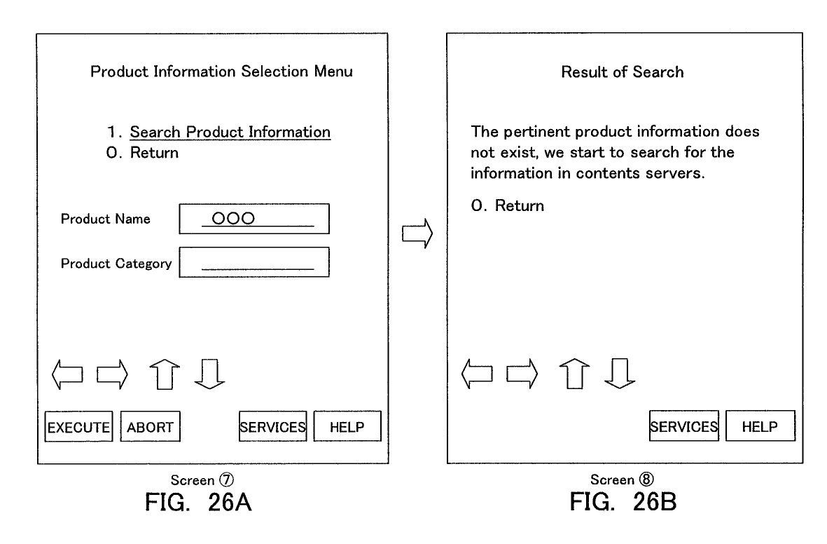

When a salesperson is talking to a customer, and there is an inquiry from the customer concerning a product, the salesperson uses terminal A to search database 93 of management server 9 for this product information. FIG. 26A is an example of a screen for searching for a product.

When the results of a search indicate that the pertinent product information does not exist, management server 9 notifies the salesperson that the pertinent product information does not exist, and the display screen shown in FIG. 26B is displayed on display portion 72 of terminal A. Further, management server 9 searches for the product information in either one or two, or more, content servers 8, and downloads retrieved product information and a URL for specifying the product information thereof.

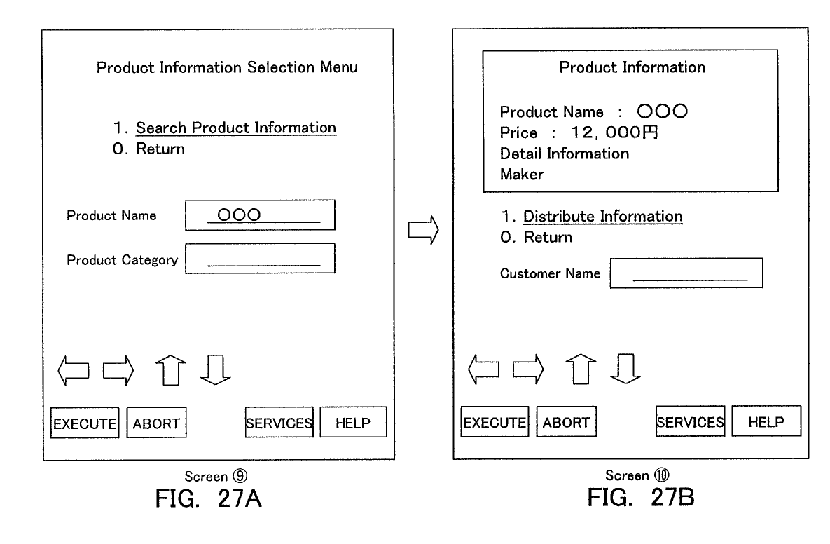

Management server 9 stores the downloaded information temporarily, and, in addition, transmits this information to terminal A of the salesperson. As a result, the screen shown in FIG. 27B is displayed on the display portion 72 of terminal A.

Upon receiving a billing-by-proxy request from content server 8, management server 9 transmits a billing-by-proxy request to carrier a. Thereafter, management server 9 transmits a change-of-billing notification to content server 8. Further, management server 9 transmits terminal A an information reception completed notification.

After confirming the product information via display portion 72 of terminal A, the salesperson uses terminal A to transmit an information-sharing request to management server 9. When management server 9 receives the information-sharing request, same downloads the product information from content server 8, temporarily stores the product information, and, in addition, downloads the product information to customer terminal B.

Upon receiving a billing-by-proxy request from content server 8, management server 9 transmits a billing-by-proxy request to carrier a, and thereafter, transmits a change-of-billing notification to content server 8.

Further, management server 9 transmits terminal A an information reception completed notification indicating that customer information-sharing has been completed. Product information is shared between the salesperson and the customer in this manner.

According to the present invention, because a management server distributes information to the terminal of a group member by carrying out the intentions of a registrant, a user of a terminal belonging to the group can share information without being burdened with the troublesome and complicated procedures for sharing information.

Further, since a registrant bears information telecommunications charges and the costs required for referencing (acquiring) information and so forth, information-sharing can be performed without a sharing partner being made to bear the charges therefor.

Furthermore, terminal-dependent information transmission can be performed by a management server converting/filtering information according to the terminal in question.

What is claimed is:

1. An information distribution device, comprising:
a first storage portion for storing terminal information including an address of each terminal device belonging to a group constituted by a plurality of terminal devices;
a first receiving portion for receiving, from a terminal device belonging to said group, a distribution request including access information and distribution destination information, said access information being required for accessing distribution information for distribution to all, some or one of said terminal devices belonging to said group, said distribution destination information specifying a distribution destination terminal device belonging to said group;
a second receiving portion for accessing said distribution information based on said access information included in a distribution request received by said first receiving portion, and for receiving the distribution information;
a second storage portion for storing said distribution information received by said second receiving portion; and
a first transmitting portion for specifying an address of a distribution destination terminal device based on said distribution destination information included in a distribution request received by said first receiving portion, and said terminal information stored in said first storage portion, and for distributing to said specified destination terminal device said distribution information stored in said second storage portion.

2. The information distribution device according to claim 1, further comprising a third receiving portion for receiving a bill of charges from a device, said device billing for said distribution information charges when said distribution information is chargeable.

3. The information distribution device according to claim 2, further comprising a second transmitting portion for transmitting said bill of charges received by said third receiving portion either to a terminal device which transmitted said distribution request or to a telecommunications carrier to which this terminal device subscribes.

4. The information distribution device according to claim 1, further comprising a deleting portion for deleting said distribution information stored in said second storage portion after the distribution of said distribution information by said first transmitting portion.

5. The information distribution device according to claim 1, further comprising a third transmitting portion for transmitting notification, to the terminal device which transmitted said distribution request, of the fact that distribution has been completed, after the distribution of said distribution information by said first transmitting portion.

6. The information distribution device according to claim 1, wherein said distribution request further includes additional information added to said distribution information, and said first transmitting portion distributes said additional information in addition to said distribution information.

7. The information distribution device according to claim 1, wherein said distribution request further includes a distribution time for specifying a time for distributing said distribution information, and said first transmitting portion distributes said distribution information at said distribution time.

8. The information distribution device according to claim 1,
wherein said terminal device information stored in said first storage portion includes information for representing an information format displayable on a display portion of the terminal device, and
wherein said information distribution device further comprises a conversion/filtering portion for converting or filtering said distribution information to a format capable of being displayed on a display portion of said terminal device, based on said information for representing said displayable information format.

9. The information distribution device according to claim 1, wherein said first receiving portion receives said distribution request from said terminal device via another server device.

10. The information distribution device according to claim 1, wherein said distribution information is either a program including a game program, said program and a license for said program, map information, or product information.

11. A terminal device, comprising:
a registration portion for registering, via a telecommunications network, terminal information including an address of each terminal device belonging to a group constituted by a plurality of terminal devices, in an information distribution device connected to the telecommunications network; and
a transmitting portion for transmitting, to said information distribution device, a distribution request including access information and distribution destination information, said access information being required for accessing distribution information for distribution to all, some or one of said terminal devices belonging to said group, said distribution destination information specifying a distribution destination terminal device belonging to said group.

12. The terminal device according to claim 11, wherein said distribution request further includes additional information added to said distribution information.

13. The terminal device according to claim 11, wherein said distribution request further includes a distribution time for specifying a time for distributing said distribution information.

14. The terminal device according to claim 11, wherein said distribution information is either a program including a game program, said program and a license for said program, map information, or product information.

15. An information distribution system having a plurality of terminal devices and an information distribution device, wherein said terminal device comprises:
a registration portion for registering, in said information distribution device, terminal information including an address of each terminal device belonging to a group constituted by a plurality of terminal devices; and
a transmitting portion for transmitting, to said information distribution device, a distribution request including access information and distribution destination information, said access information being required for accessing distribution information for distribution to all, some or one of said terminal devices belonging to said group, said distribution destination information specifying a distribution destination terminal device belonging to said group,
and wherein said information distribution device comprises:
a first storage portion for storing terminal information registered by said registration portion of said terminal device,
a first receiving portion for receiving said distribution request transmitted by said transmitting portion;
a second receiving portion for accessing said distribution information based on said access information included in a distribution request received by said first receiving portion, and for receiving said distribution information; and
a distributing portion for specifying an address of a distribution destination terminal device based on said distribution destination information included in a distribution request received by said first receiving portion, and terminal information stored in said first storage portion, and for distributing, to said specified destination terminal device, distribution information received by said second receiving portion.

16. An information distribution method, performed by a server device which stores terminal information including an address of each terminal device belonging to a group constituted by a plurality of terminal devices, comprising the steps of:
receiving, from a terminal device belonging to said group, a distribution request including access information and distribution destination information, said access information being required for accessing distribution information for distribution to all, some or one of said terminal devices belonging to said group, said distribution destination information specifying a distribution destination terminal device belonging to said group;
accessing said distribution information based on said access information included in said received distribution request, and receiving said distribution information; and
specifying an address of a distribution destination terminal device based on said distribution destination information included in said received distribution request, and said stored terminal information, and distributing said received distribution information to said destination terminal device.

17. An information distribution method, performed by a terminal device connected to a telecommunications network, comprising the steps of:
registering, via said telecommunications network, terminal information including an address of each terminal device belonging to a group constituted by a plurality of terminal devices, in an information distribution device connected to this telecommunications network; and
transmitting, to said information distribution device, a distribution request Including access information and distribution destination information, said access information being required for accessing distribution information for distribution to all, some or one of said terminal devices belonging to said group, said distribution destination information specifying a distribution destination terminal device belonging to said group.

18. An information distribution method for an information distribution system having a plurality of terminal devices and an information distribution device, comprising steps of:
said terminal device registering, in said information distribution device, terminal information including an address of each terminal device belonging to a group constituted by a plurality of terminal devices;
said terminal device transmitting, to said information distribution device, a distribution request including access information and distribution destination information, said access information being required for accessing distribution information for distribution to all, some or one of said terminal devices belonging to said group, said distribution destination information specifying a distribution destination terminal device belonging to said group,
said information distribution device storing said terminal information registered by said terminal device;
said information distribution device receiving said distribution request transmitted from said terminal device;
said information distribution device accessing said distribution information based on said access information included in said received distribution request, and receiving said distribution information; and
said information distribution device specifying an address of a distribution destination terminal device based on said distribution destination information included in said received distribution request, and said terminal information, and distributing said received distribution information to said specified destination terminal device.

19. An information distribution program product, comprising:
a receiving process for receiving, from a terminal device belonging to a group constituted by a plurality of terminal devices, a distribution request including access information and distribution destination information, said access information being required for accessing distribution information for distribution to all, some or one of said terminal devices belonging to said group, said distribution destination information specifying a distribution destination terminal device belonging to said group;
a accessing process for accessing said distribution information based on said access information included in said received distribution request, to receive the distribution information; and
a specifying process for specifying an address of a distribution destination terminal device based on said distribution destination information included in said received distribution request, and terminal information including an address of each terminal device belonging to said group, to distribute said received distribution information to said destination terminal device.

20. An information distribution program product, comprising:
a registering process for registering, via a telecommunications network, terminal information including an address of each terminal device belonging to a group constituted by a plurality of terminal devices, in an information distribution device connected to the telecommunications network; and
a transmitting process for transmitting, to said information distribution device, a distribution request including access information and distribution destination information, said access information being required for accessing distribution information for distribution to all, some or one of said terminal devices belonging to said group, said distribution destination information specifying a distribution destination terminal device belonging to said group.
